(19) United States
(12) Patent Application Publication
(10) Pub. No.: US 2025/0391965 A1
(43) Pub. Date: Dec. 25, 2025

(54) COMPOSITE MATERIAL AND BATTERY DEVICE COMPRISING THE SAME

(71) Applicant: BASF SE, Ludwigshafen Am Rhein (DE)

(72) Inventors: He Meng ZHAO, Shanghai (CN); Xu CHEN, Shanghai (CN); Chao XU, Shanghai (CN); Xin Yao LV, Shanghai (CN)

(73) Assignee: BASF SE, Ludwigshafen Am Rhein (DE)

(21) Appl. No.: 18/876,711

(22) PCT Filed: Jun. 5, 2023
(86) PCT No.: PCT/EP2023/064906

§ 371 Date: Dec. 19, 2024

(30) Foreign Application Priority Data
Jun. 22, 2022 (CN) 202221567070.1

(51) Int. Cl. H01M 50/131; H01M 50/124; H01M 50/375

(52) U.S. Cl. CPC H01M 50/131; H01M 50/1245; H01M 50/375

(57) ABSTRACT

The present invention discloses a composite material for making a housing of a battery device, comprising a substrate layer (10) and a first fireproof coating (20), which is coated on at least a portion of a surface of the substrate layer (10). the first fireproof coating (20) having a thickness of 0.3 mm to 1.5 mm. The composite material has the advantages of both fire protection and light weight. Furthermore, the composite material further has the advantage of thermal insulation.

### TECHNICAL FIELD

The present invention relates to the battery field. More specifically, the present invention relates to a composite material for making a housing of a battery device, and a battery device comprising the housing.

### BACKGROUND ART

In recent years, thermal runaway accidents of battery devices in new energy vehicles have occurred from time to time. Accordingly, the automotive industry has made increasingly higher requirements for the fire protection of battery devices. In addition, in order to improve the driving mileage, the automotive industry also has made increasingly higher requirements for lightweight battery devices.

Therefore, there is still a need to continuously develop a new composite material that is lightweight and has an excellent fireproof performance for making a housing of a battery device, so as to better adapt to the performance requirements of modern new energy vehicles.

### SUMMARY OF THE INVENTION

In view of the above problems, the object of the invention is to provide a composite material that is lightweight and has an excellent fireproof performance.

In a first aspect of the present invention, a composite material is provided for making a housing of a battery device, characterized in that it comprises:
a substrate layer (10); and
a first fireproof coating (20), which is coated on at least a portion of a surface of the substrate layer (10), said first fireproof coating (20) having a thickness of 0.3 mm to 1.5 mm.

In some embodiments, the composite material further comprises a fiber reinforced resin layer (30), which is located between the substrate layer (10) and the first fireproof coating (20), the fiber reinforced resin layer (30) comprising a reinforcing fiber and a resin enclosing the reinforcing fiber. In a further embodiment, the composite material further comprises a dielectric layer (40), which is located between the substrate layer (10) and the first fireproof coating (20), or between the substrate layer (10) and the fiber reinforced resin layer (30).

In a still further embodiment, the composite material further comprises a panel layer (50), which is located on the surface of the first fireproof coating (20) that is away from the substrate layer (10), the panel layer (50) being of a resin material.

In a yet still further embodiment, the composite material further comprises a second fireproof coating (20′), which is coated on at least a portion of the surface of the substrate layer (10) on the side opposite to the first fireproof coating (20), the second fireproof coating (20′) having a thickness of 0.3 mm to 1.5 mm.

In a yet still further embodiment, the composite material further comprises a thermal insulation layer (60), which is arranged on the surface of the substrate layer (10) on the side opposite to the first fireproof coating (20) or on a surface of the second fireproof coating (20′), the thermal insulation layer (60) being made of a porous material.

Furthermore, the present invention provides a housing for a battery device, wherein the material of the housing is a composite material mentioned above, and the housing is a top cover, a bottom plate and/or a side plate of the battery device.

In addition, the present invention further provides a battery device comprising the housing, such as a battery cell, a battery module and a battery pack.

### Beneficial Effects

The composite material of the present invention is not only lightweight but also excellent in fireproof performance, which can not only significantly reduce the total weight of a battery device, but also improve the safety factor of the battery device.

### BRIEF DESCRIPTION OF THE DRAWINGS

In order to illustrate more clearly the embodiments of the present invention, the drawings required in connection with the description of the embodiments will be briefly introduced below. Apparently, the drawings in the following description show only some embodiments of the present invention. For a person of ordinary skill in the art, simple replacements/modifications can also be made based on these drawings so as to obtain other embodiments.

FIG. 1 is a structural schematic diagram of a composite material of some embodiments of the present invention;

FIG. 2 is a structural schematic diagram of a composite material of other embodiments of the present invention;

FIG. 3 is a structural schematic diagram of a composite material of other embodiments of the present invention;

FIG. 4 is a structural schematic diagram of a composite material of other embodiments of the present invention;

FIG. 5 is a structural schematic diagram of a composite material of other embodiments of the present invention;

FIG. 6 is a structural schematic diagram of a composite material of other embodiments of the present invention;

FIGS. 7A to 7C are structural schematic diagrams of a composite material of other embodiments of the present invention;

FIG. 8 is a structural schematic diagram of a composite material of other embodiments of the present invention;

In the drawings,
10: substrate layer;
20: first fireproof coating;
20′: second fireproof coating;
30: fiber reinforced resin layer;
40: dielectric layer;
50: panel layer;
60: thermal insulation layer; and
70: waterproof layer.

### MODE OF CARRYING OUT THE INVENTION

The technical solutions in the embodiments of the present invention will be described clearly and completely below with reference to the drawings of the present invention. Obviously, the described embodiments are only a part of the embodiments of the present invention, not all of them. All other embodiments obtained by the person of ordinary skill in the art based on the embodiments of the present invention without exercising creative efforts fall within the scope of protection of the present invention.

As mentioned above, the current housing materials of battery devices have problems of heavy weight, insufficient fireproof performance, and the like.

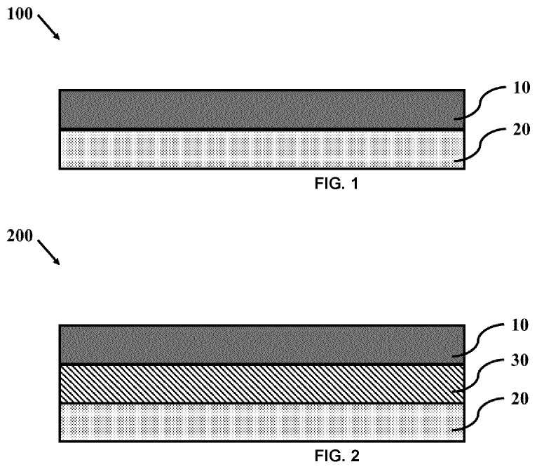

Addressing such problems, referring to FIG. 1, the present invention provides a composite material 100 for making a housing of a battery device, comprising a substrate layer 10 and a first fireproof coating 20, which is coated on at least a portion of a surface of the substrate layer and has a thickness of 0.3 mm to 1.5 mm.

The first fireproof coating has strong fire resistance and can slow down the conduction of high temperatures to the surrounding environment, thereby preventing combustion for a certain period of time. The housing made by coating a fireproof coating on the substrate layer can serve as a protective barrier, thus timely blocking the high temperature generated by local thermal runaway of a battery device from spreading to the surrounding areas, and thereby inhibiting or delaying ignition and explosion of the battery device.

In addition, in the present invention, the first fireproof coating is ultra-thin, i.e., its thickness is 0.3 mm to 1.5 mm, such as 0.5 mm, 0.8 mm, 1 mm, 1.2 mm or 1.5 mm. When the thickness of the first fireproof coating is too small, it will affect the thermal-insulating and fireproof performance of the composite material; and when the thickness of the first fireproof coating is too large, it will affect the weight of the composite material. On the other hand, when the first fireproof coating is a (micro) expansion type fireproof coating, excessive coating thickness causes excessive expansion of the fireproof coating, so as to occupy a limited space. The inventor of the present invention found that, by setting the thickness of the first fireproof coating to be 0.3 mm to 1.5 mm, the composite material according to the present invention has the advantages of both fire protection and light weight.

In some embodiments, the first fireproof coating is coated on at least a portion of a surface of the substrate layer, for example, 30% to 100% of a surface of the substrate layer. When the composite material 100 is used for making a housing of a battery pack, it is preferable to provide the first fireproof coating only at a housing position corresponding to a pressure relief valve (also referred to as an exhaust valve) on a battery module inside the battery pack. This is because when the thermal runaway of the battery module occurs, the housing position corresponding to the pressure relief valve is the position to receive the thermal impact of a high-temperature gas, and providing the first fireproof coating only at a housing position corresponding to the pressure relief valve can reduce the amount of fireproof paints used on the housing surface.

In some embodiments, the substrate layer can be a metal material or a resin material, i.e., the substrate layer can be made of a metal material, or can be made of a resin material. The substrate layer, as a structural part of a battery device, must have a certain mechanical strength to protect the internal battery elements from being damaged when they are impacted and squeezed from the outside, and/or bear the weight of the internal battery elements. In addition, the substrate layer also has a waterproof effect. Exemplary metal materials include aluminum alloys, iron, steel, aluminum, and the like. Exemplary resin materials include polyurethane, polyurea, epoxy resin, unsaturated resin, and the like.

In some embodiments, the thickness of the substrate layer is 0.3 mm to 3.5 mm. In particular, when the substrate layer is made of a metal material, its thickness is preferably 0.5 mm to 2 mm, such as 0.5 mm, 1 mm, 1.5 mm or 2 mm; and when the substrate layer is made of a resin material, its thickness is preferably 1 mm to 3.5 mm, such as 0.5 mm, 1 mm, 1.5 mm, 2 mm, 2.5 mm, 3 mm or 3.5 mm. As mentioned above, the first fireproof coating has excellent thermal-insulating and fireproof performance, thus allowing the thickness of the substrate layer of the present invention to be set relatively low so as to meet the expectation of lightweight battery devices.

In some embodiments, the first fireproof coating is a micro-expansion type fireproof coating. The micro-expansion type fireproof coating has an expansion factor of 2-20 times, preferably 3-15 times. The expansion factor refers to the ratio of the thickness of a fireproof coating after thermal expansion to the thickness before expansion. When a high temperature is generated by the local thermal runaway of a battery device, the first fireproof coating is slightly expanded after being heated, and can release non-combustible gas to reduce the oxygen density inside the battery device. Furthermore, the first fireproof coating may also form an expansion thermal insulation layer that is several times to tens of times thicker than the original coating, such as 2 to 20 times, preferably 3 to 15 times. On one hand, the formed expansion thermal insulation layer can isolate the contained battery elements from the surrounding environment to block oxygen; and on the other hand, due to the fact that its own material of a loose nature also has a good thermal insulation performance, it can form a thermal insulation barrier to block the diffusion of high temperatures to the surrounding areas and thus protect the underlying substrate layer from being damaged.

The aforementioned micro-expansion type fireproof coating is made of a micro-expansion type fireproof paint. By using a micro-expansion type fireproof paint, the formed expansion thermal insulation layer is not too thick, thereby avoiding damaging, by excessive expansion of the first fireproof coating, the battery elements contained inside the housing or adjacent to it, such as battery modules, battery cells, or bare cells, so as to meet the requirement of limited internal gaps in battery devices.

Specifically, the micro-expansion type fireproof paints mainly include resins, acid sources, and expansive agents. Suitable resins include polyurethane, polyurea, epoxy resin, and the like, with polyurethane being preferred. Resin-based fireproof paints have the characteristics of excellent adhesive strength, good weather resistance, good water resistance, good leveling property and the like. In addition, due to the absence of substances with high carbon content, such as expanded graphite, the micro-expansion type fireproof coating will not be excessively expanded after being heated.

When a fireproof coating is exposed to a high temperature, acid sources can release non-combustible gases, such as sulfur dioxide and ammonia, to dilute the density of the surrounding oxygen and promote the formation of the expansion thermal insulation layer. Suitable acid sources include, but are not limited to, phosphorus-containing compounds and sulfur-containing compounds. The phosphorus-containing compounds include phosphates and phosphate esters, such as sodium phosphate, potassium phosphate or ammonium phosphate, ammonium polyphosphate (APP), monoammonium phosphate, diammonium hydrogen phosphate, trichloroethyl phosphate (TCEP), trichloropropyl phosphate (TCPP), ammonium pyrophosphate, triphenyl phosphate, etc. The sulfur-containing compounds include sulfonates, such as sodium sulfonate, potassium sulfonate or sulfonic acid, p-toluenesulfonic acid, and sulfates, such as sodium sulfate, potassium sulfate or ammonium sulfate.

When a fireproof coating is exposed to a high temperature, expansive agents can produce non-combustible gases, such as nitrogen and ammonia, to further dilute the density of the surrounding oxygen and facilitate the expansion of the fireproof coating. Suitable expansive agents include, but are not limited to, melamine compounds and boron-containing compounds. The melamine compounds include melamine salts, such as melamine cyanurate, melamine formaldehyde, hydroxymethylated melamine, hexamethoxymethyl melamine, melamine monophosphate, di (melamine phosphate), melamine dihydrogen phosphate, etc.; boron-containing compounds include boric acid, borates and borate esters, such as ammonium pentaborate, zinc borate, sodium borate, lithium borate, aluminum borate, magnesium borate and borosilicate.

It should be understood that the aforementioned micro-expansion type fireproof coatings can also include inorganic fillers, other flame retardants, etc. Suitable inorganic fillers include, but are not limited to, metal oxides, hydroxides, and (mineral) salts.

The substrate layer can be pre-formed into a desired shape by processing such as cutting and hot pressing as needed. The first fireproof coating can be coated on a surface of the substrate layer by a method such as roller coating, dip coating, brush coating or spraying to obtain the composite material 100. It should be understood that the person skilled in the art can choose appropriate processing methods according to the specific application scenarios. The preparation process of the composite material according to the present invention is simple and suitable for a workshop assembly line process.

The composite material of the present invention is further introduced below with reference to FIGS. 2 to 5.

As shown in FIG. 2, in some embodiments, the composite material 200 according to the present invention further comprises a fiber reinforced resin layer 30, which is located between the substrate layer 10 and the first fireproof coating 20, the fiber reinforced resin layer 30 comprising reinforcing fibers and a resin enclosing the reinforcing fibers.

Both the reinforcing fibers and the resin mentioned above can be selected from materials known in the art. For example, suitable resin materials include polyurethane, polyurea, epoxy resin, unsaturated resin, and the like, and polyurethane resin is preferred. Suitable reinforcing fiber materials include glass fiber, carbon fiber, natural fiber, non-woven fabric, and the like, and glass fiber is preferred. By providing a fiber reinforced resin layer 30 between the substrate layer 10 and the first fireproof coating 20, not only can the mechanical strength of the composite material be significantly improved, but also the fiber reinforced resin layer can further ensure that the composite material, owing to its superior fire resistance, maintains its structural integrity after undergoing fire.

The thickness of the fiber reinforced resin layer can be 0.3 mm to 1 mm, such as 0.3 mm, 0.5 mm, 0.8 mm or 1 mm. An appropriate thickness can be selected by the person skilled in the art according to the specific scenario of the composite material.

The fiber reinforced resin layer can be integrally formed by adding reinforcing fibers to the resin and then curing it by hot pressing, or can be integrally formed by spraying a resin material to a reinforced fiber product (such as a fiber felt) and then curing it by hot pressing. In the produced fiber reinforced resin layer, the resin material is filled in the pores of the reinforcing fibers and encloses the reinforcing fibers.

Accordingly, the composite material 200 can be made by first laminating the fiber reinforced resin layer 30 on the substrate layer 10 for hot-pressing joining, and then coating the surface of the fiber reinforced resin layer with a fireproof paint. It should be understood that the person skilled in the art can make appropriate adjustments to the preparation process and the sequence of steps as needed.

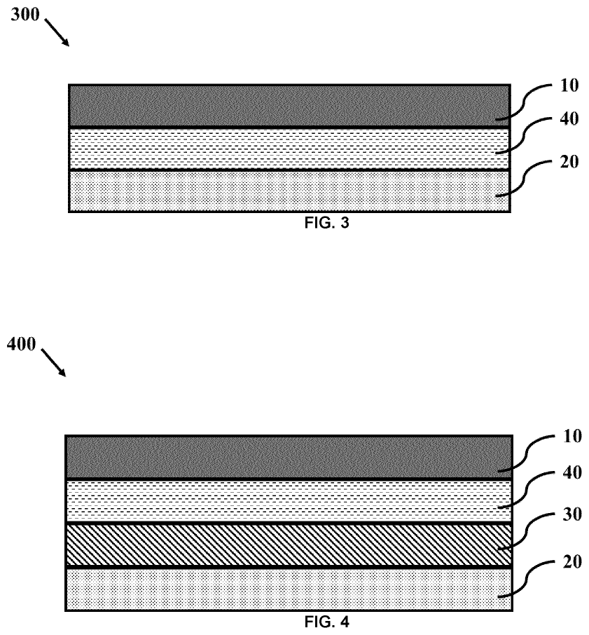

As shown in FIG. 3, in some embodiments, when the substrate layer 10 is a metal material, the composite material 300 according to the present invention further comprises a dielectric layer 40, which is located between the substrate layer 10 and the first fireproof coating 20. As shown in FIG. 4, in some alternative embodiments, the composite material 400 according to the present invention comprises both a fiber reinforced resin layer 30 and a dielectric layer 40, which is located between the substrate layer 10 and the fiber reinforced resin layer 30.

The dielectric layer can protect the metal materials in the substrate layer and has anti-corrosion/waterproof and insulating effects. Suitable dielectric layer materials can be epoxy resins, acrylic resins, and other suitable organic coatings.

The thickness of the dielectric layer is not particularly limited in the present invention, and can be adjusted by the person skilled in the art according to actual needs. In some embodiments, the thickness of the dielectric layer can be 10 μm to 50 μm, such as 10 μm, 20 μm, 25 μm, 30 μm, 40 μm, or 50 μm.

The dielectric layer can be formed on a surface of the substrate layer by electrophoresis, brushing coating, roller coating, spraying, etc. Subsequently, the aforementioned first fireproof coating is coated on a surface of the dielectric layer to obtain the composite material 300; or a fiber reinforced resin layer is first laminated on a surface of the dielectric layer and hot-pressed, and then coated with the first fireproof coating to obtain a composite material 400.

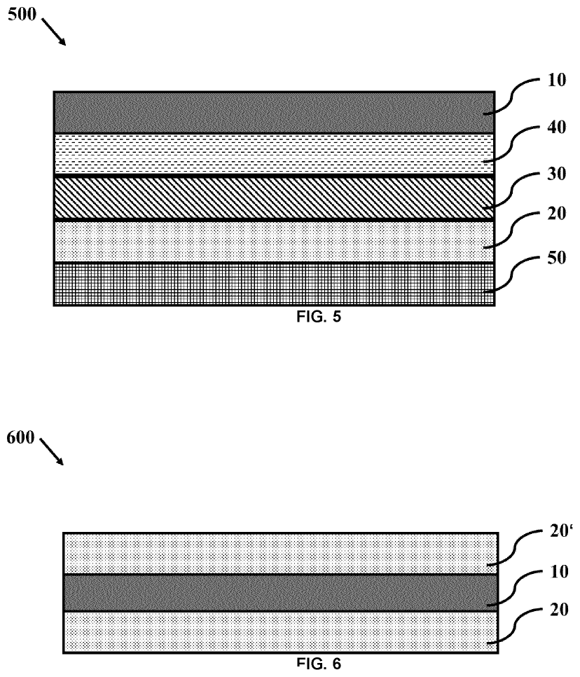

Furthermore, as shown in FIG. 5, in some embodiments, a composite material 500 according to the present invention further comprises a panel layer 50, which is located on the surface of the first fireproof coating 20 that is away from the substrate layer 10, the panel layer being a resin material. Suitable resin materials include polyurethane, polyurea, epoxy resin, unsaturated resin, and the like.

By providing a panel layer on a surface of the first fireproof coating, the first fireproof coating can be prevented from being damaged during transportation and use. The panel layer can be joined to the first fireproof coating by hot pressing or the like after being laminated to the surface of the first fireproof coating.

It can be understood that the panel layer 50 can also be arranged on the surface of the first fireproof coating of the composite material as shown in FIGS. 1 to 4 to protect the first fireproof coating.

It should also be understood that the aforementioned embodiments and drawings are merely exemplary, and that the combination order and/or quantity of materials may be suitably adjusted by the person skilled in the art without departing from the spirit of the present invention. For example, in the embodiments described according to the above paragraphs and/or shown in FIGS. 1 to 5, a fireproof coating, a fiber reinforced resin layer, a dielectric layer and/or a panel layer can also be provided on the other side of the substrate layer 10. As shown in FIG. 6, the composite material 600 further comprises a second fireproof coating 20′, which is coated on at least a portion of a surface of the substrate layer 10 on the side opposite to the first fireproof coating 20, and has a thickness of 0.3 mm to 1.5 mm. Optionally, a dielectric layer, and/or a fiber reinforced resin layer can also be provided between the substrate layer and the second fireproof coating, respectively, and a panel layer is provided on an outer surface of the second fireproof coating. The second fireproof coating 20′ has the same material, properties, preparation process, performance and the like as the aforementioned first fireproof coating 20, and thus will not be repeatedly described herein.

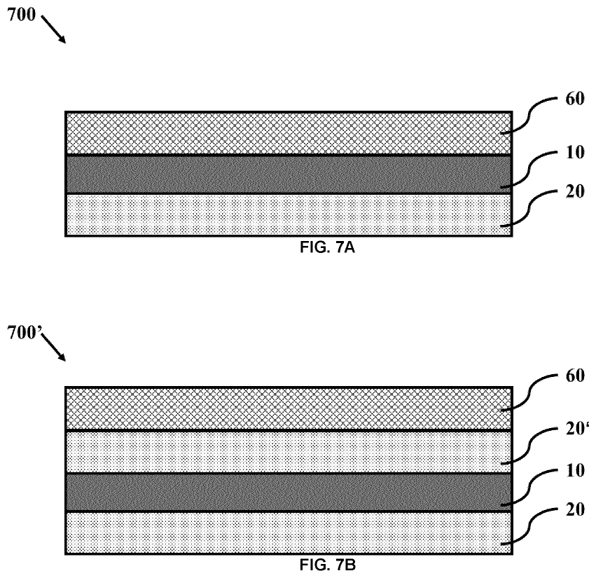

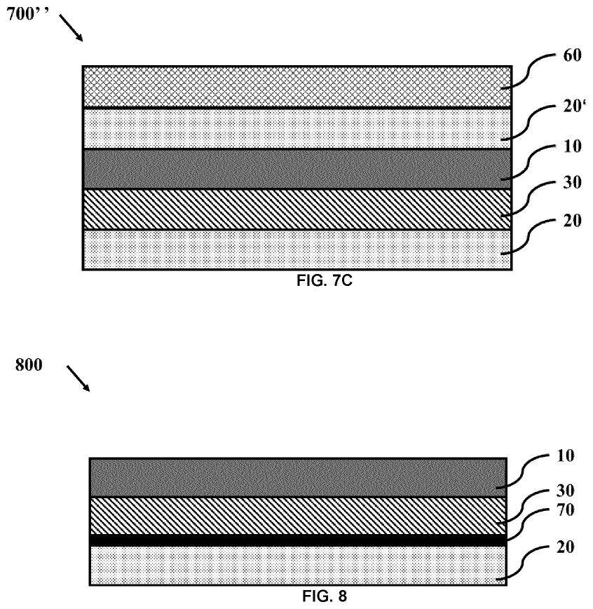

Furthermore, as shown in FIG. 7A, the composite material 700 can further comprise a thermal insulation layer 60, which is disposed on the surface of the substrate layer 10 on the side opposite to the first fireproof coating 20, and is made of a porous material. The porous material includes, for example, porous ceramic, a glass fiber felt, an aerogel, an expandable material (e.g., expandable graphite), and the like. Optionally, as shown in FIG. 7B, in the composite material 700′, the thermal insulation layer 60 can also be disposed on the surface of the second fireproof coating 20′. In another specific embodiment, as shown in FIG. 7C, the composite material 700″ comprises a first fireproof coating 20, a fiber reinforced resin layer 30, a substrate layer 10, a second fireproof coating 20′, and a thermal insulation layer 60, which are laminated in sequence.

Although the composite material shown in FIGS. 7A to 7C comprise only the substrate layer 10, the first fireproof coating 20, the second fireproof coating 20′, the fiber reinforced resin layer 30, and the thermal insulation layer 60, it should be understood that the composite material can further comprise a dielectric layer, and/or a panel layer as described above.

The porous material has a good thermal insulation performance because the pores of the porous material are filled with air or other low-thermal-conductivity media, which reduce the thermal conductivity of the material to a very low extent. By providing a thermal insulation layer on the surface of the substrate layer 10 on the side opposite to the first fireproof coating 20 or on a surface of the second fireproof coating 20′, the composite material is made to have the advantage of thermal insulation in addition to the fireproof and lightweight effects mentioned above, thereby further reducing the impact of a high temperature generated by thermal runaway inside the battery device on components around the battery device.

In other embodiments, the composite material further comprises a waterproof layer 70, which is arranged on one or both sides of the fiber reinforced resin layer 30. In the present invention, the thickness of the waterproof layer is 0.01 to 1 mm, preferably 0.02 to 0.3 mm.

The waterproof layer comprises a metal sheet or a plastic sheet known in the art. Preferably, the metal sheet is selected from the group consisting of aluminum alloy, iron, steel and aluminum. Preferably, the plastic sheet is at least one material selected from the group consisting of polyethylene (PE), polyvinyl chloride (PVC), polyethylene terephthalate (PET), polybutylene terephthalate (PBT), polypropylene (PP), thermoplastic polyurethane (TPU), polyurethane (PU), polyamide (PA), polyvinyl butyral (PVB) and ethylene-vinyl acetate copolymer (EVA). In a preferred embodiment, the plastic sheet is selected from polyurethane (PU), more preferably thermoplastic polyurethane (TPU).

As shown in FIG. 8, the composite material 800 further comprises a waterproof layer 70, which can be arranged between the fiber reinforced resin layer 30 and the first fireproof coating 20. The composite material 800 can be integrally formed by first laminating the waterproof layer on a reinforced fiber product (such as a fiber felt), spraying a resin material, and then curing it by hot-pressing; then the obtained fiber reinforced resin layer and the waterproof layer are together placed on the substrate layer for hot-pressing joining; and finally, the surface of the waterproof layer is coated with a fireproof paint. It should be understood that the person skilled in the art can make appropriate adjustments to the preparation process and the sequence of steps as needed.

It should also be understood that the composite material can also comprise more than one waterproof layer and fiber reinforced resin layer, and the waterproof layer and fiber reinforced resin layer can also be located on the other side of the substrate layer. The number and the location of the waterproof layer and the fiber reinforced resin layer can be appropriately adjusted by the person skilled in the art according to specific needs. Accordingly, the preparation method of the composite material is also adaptively adjusted.

By additionally providing a waterproof layer in the composite material, the waterproof performance of the composite material can be further improved. In particular, when the composite material is used for making a housing of a battery device, the battery device can still have a good waterproof effect even when soaked in water.

In a second aspect of the present invention, a housing is provided for a battery device, wherein the material of the housing is a composite material as described according to the aforementioned first aspect, and the housing is a top cover, a bottom plate and/or a side plate of the battery device. For example, in some embodiments, the composite material is used only for making a top cover of a battery device, while in other embodiments, the composite material may be used for making a top cover, a bottom plate and a side plate of a battery device at the same time. In addition, the battery device includes, for example, a battery cell, a battery module, and a battery pack.

In a third aspect of the present invention, a battery cell is further provided, comprising a housing and a bare cell located inside the housing, the material of the housing of the battery cell being a composite material as described according to the aforementioned first aspect, wherein the first fireproof coating 20 is located on the side of the housing that is away from the bare cell.

In a fourth aspect of the present invention, a battery module is provided, comprising a housing and a plurality of battery cells located inside the housing, wherein the housing comprises a top cover, a bottom plate and a side plate, and the material of at least one of the top cover, the bottom plate and the side plate is a composite material as described according to the aforementioned first aspect, wherein the first fireproof coating 20 is located on the side of the housing that is near the battery cell. In some embodiments, the battery cell is a battery cell as described according to the aforementioned third aspect.

In a fifth aspect of the present invention, a battery pack is provided, comprising a housing and a plurality of battery modules located inside the housing, wherein the housing comprises a top cover, a bottom plate and a side plate, and the material of at least one of the top cover, the bottom plate and the side plate is a composite material as described according to the aforementioned first aspect, wherein the first fireproof coating 20 is located on the side of the housing that is near the battery module. In some embodiments, the battery module is a battery module as described according to the aforementioned fourth aspect.

In some specific embodiments, the composite material for making a housing of a battery pack further comprises a second fireproof coating 20′, which is coated on at least a portion of the surface of the substrate layer 10 on the side opposite to the first fireproof coating 20, the second fireproof coating 20′ having a thickness of 0.3 mm to 1.5 mm. That is, the second fireproof coating 20′ is located on the side of the housing that is away from the battery module. In other embodiments, the composite material for making a housing of a battery pack further comprises a thermal insulation layer 60, which is disposed on the surface of the substrate layer 10 on the side opposite to the first fireproof coating 20 or on a surface of the second fireproof coating 20′. The thermal insulation layer 60 is made of a porous material. The porous material includes, for example, porous ceramic, a glass fiber felt, an aerogel, an expandable material (e.g., expandable graphite), and the like.

As mentioned above, by providing a thermal insulation layer on the surface of the substrate layer 10 on the side opposite to the first fireproof coating 20 or on a surface of the second fireproof coating 20′, the composite material is made to have the advantage of thermal insulation in addition to the fireproof and lightweight effects mentioned above, thereby further reducing the impact of a high temperature generated by thermal runaway inside a battery pack on components around the battery pack.

In some embodiments, the battery module inside the battery pack mentioned above further comprises a pressure relief valve, and the first fireproof coating 20 is arranged only at a housing position corresponding to the pressure relief valve. This is because when thermal runaway of the battery module occurs, the housing corresponding to the pressure relief valve is the first to receive the thermal impact of a high temperature gas, and setting the first fireproof coating only at a housing position corresponding to the pressure relief valve can reduce the amount of fireproof paints used on the housing surface.

As mentioned above, the composite material described according to the first aspect of the present invention has the advantages of both fire protection and light weight. Therefore, the housing made of the composite material can prevent high temperature from spreading outward to the adjacent battery cells or battery modules when bare cells, battery cells and battery modules contained in the housing undergo thermal runaway. In particular, the housing can also protect the bare cells, the battery cells and the battery modules contained inside it from external mechanical shock and high temperature impact, thus ensuring the safe use of a battery device.

The above describes the basic principles and exemplary embodiments of the present invention. The person skilled in the art will understand that the above description is only for the purpose of illustrating the present invention, and the present invention is not limited by the aforementioned embodiments. Without departing from the spirit and scope of the present invention, the present invention can also have various variations and improvements, which all fall within the scope of protection claimed by the present invention.

1. A composite material for making a housing of a battery device, comprising:
a substrate layer; and
a first fireproof coating, which is coated on at least a portion of a surface of the substrate layer, the first fireproof coating having a thickness of 0.3 mm to 1.5 mm.

2. The composite material according to claim 1, further comprising a fiber reinforced resin layer, which is located between the substrate layer and the first fireproof coating, the fiber reinforced resin layer comprising a reinforcing fiber and a resin enclosing the reinforcing fiber.

3. The composite material according to claim 2, wherein a thickness of the fiber reinforced resin layer is 0.3 mm to 1 mm.

4. The composite material according to claim 1, wherein the substrate layer is made of a resin material or a metal material.

5. The composite material according to claim 1, wherein a thickness of the substrate layer (10) is 0.3 mm to 3.5 mm.

6. The composite material according to claim 1, wherein the first fireproof coating is a micro-expansion fireproof coating, which has an expansion factor of 2-20 times.

7. The composite material according to claim 6, wherein the micro-expansion fireproof coating is made of a micro-expansion fireproof paint, and the micro-expansion fireproof paint includes resins, acid sources which include phosphorus-containing compounds and sulfur-containing compounds, and expansive agents which include melamine compounds and boron-containing compounds.

8. The composite material according to claim 7, wherein the micro-expansion fireproof coating further comprises inorganic fillers.

9. The composite material according to claim 1, wherein the substrate layer is made of a metal material, and the composite material further comprises a dielectric layer, which is located between the substrate layer and the first fireproof coating.

10. The composite material according to claim 1, wherein the composite material further comprises a panel layer, which is located on the surface of the first fireproof coating that is away from the substrate layer, the panel layer being made of a resin material.

11. The composite material according to claim 1, wherein the composite material further comprises a second fireproof coating, which is coated on at least a portion of the surface of the substrate layer on a side opposite to the first fireproof coating, the second fireproof coating having a thickness of 0.3 mm to 1.5 mm.

12. The composite material according to claim 1, wherein the composite material further comprises a waterproof layer which is arranged on one or both sides of the fiber reinforced resin layer, the waterproof layer having a thickness of 0.01 to 1 mm.

13. The composite material according to claim 1, wherein the composite material further comprises a thermal insulation layer which is arranged on the surface of the substrate layer on a side opposite to the first fireproof coating.

14. A housing for a battery device, wherein the material of the housing is a composite material according to claim 1, and the housing is a top cover, a bottom plate, and/or a side plate of the battery device.

15. The housing according to claim 14, wherein the battery device comprises a battery cell, a battery module, and a battery pack.

16. A battery cell, comprising a housing and a bare cell located inside the housing, wherein the material of the housing of the battery cell is a composite material according to claim 1, wherein the first fireproof coating is located on a side of the housing that is away from the bare cell.

17. A battery module comprising a housing and a plurality of battery cells located inside the housing, wherein the housing comprises a top cover, a bottom plate and a side plate, and the material of at least one of the top cover, the bottom plate and the side plates is a composite material according to claim 1, wherein the first fireproof coating is located on a side of the housing that is near the battery cell.

18. A battery pack comprising a housing and a plurality of battery modules located inside the housing, wherein the housing comprises a top cover, a bottom plate and a side plate, and the material of at least one of the top cover, the bottom plate and the side plate is a composite material according to claim 1, wherein the first fireproof coating is located on a side of the housing that is near the battery module.

19. The battery pack according to claim 18, wherein the battery module comprises a pressure relief valve, and the first fireproof coating in the composite material is arranged only at a housing position corresponding to the pressure relief valve.
